(19) United States
(12) Patent Application Publication
(10) Pub. No.: US 2023/0008660 A1
(43) Pub. Date: Jan. 12, 2023

(54) METHOD OF ANALYZING CONTAINER SYSTEM CALL CONFIGURATION ERROR, AND RECORDING MEDIUM AND APPARATUS FOR PERFORMING THE SAME

(71) Applicant: Foundation of Soongsil University-Industry Cooperation, Seoul (KR)

(72) Inventors: Soohwan JUNG, Seoul (KR); Thien-Phuc DOAN, Seoul (KR); Songi GWAK, Seoul (KR)

(21) Appl. No.: 17/877,148

(22) Filed: Jul. 29, 2022

Related U.S. Application Data
(63) Continuation-in-part of application No. PCT/KR2022/004893, filed on Apr. 5, 2022.

(30) Foreign Application Priority Data
Jul. 8, 2021 (KR) 10-2021-0089548

(51) Int. Cl. G06F 21/56; G06F 21/52

(52) U.S. Cl. CPC G06F 21/566; G06F 21/52; G06F 2221/034

(57) ABSTRACT

Provided is a method of analyzing a container system call configuration error, including: profiling a set of trusted images that are uploaded to a public or private container image repository during initialization of a system or verified by a repository owner; identifying a custom service layer and known service layers based on the trusted image when a custom image is transmitted to the system; analyzing only the custom service layer by a system call extraction engine; and generating and optimizing a profile with an essential and non-malicious system call by scanning the custom service layer to remove a malicious program or a vulnerable system call. Accordingly, it is possible to reduce overhead by omitting re-analysis of known images in a container image scanning process.

### CROSS-REFERENCE TO RELATED APPLICATION(S)

The present application is a continuation-in-part of international patent application No. PCT/KR2022/004893 filed on Apr. 5, 2022, and claims priority to Korean patent application No. 10-2021-0089548 filed on Jul. 8, 2021, the entire contents of which are hereby incorporated by reference.

### TECHNICAL FIELD

The present invention relates to a method of analyzing a container system call configuration error, and a recording medium and an apparatus for performing the same, and more particularly, to a technology of separating a custom image into two parts to avoid re-analysis of the already known image and optimizing a container image scanning process to generate a system call filtering profile by approving or rejecting dangerous system calls based on a scoring system.

### BACKGROUND ART

In computing, a system call is a programming method for requesting a service from a kernel of an operating system in which a program is executed, and is a method of interacting with the operating system for the program. When making a request to the kernel of the operating system, the computer program generates a system call. The system call provides a service of the operating system to a user's program through an application program interface (API).

Most container engines provide configurations to improve system security. Since the system calls directly affect system execution commands, system call control is a powerful solution for container attacks.

The container engine provides a configuration for seccomp. This system filters system calls called from a process and its child processes, and a method of generating a seccomp profile is called seccomp profiling.

There are two attack vectors as system call configuration errors. First, container images are vulnerable. The container has vulnerabilities in that it may be attacked by remote attackers. These attacks use sensitive system calls to successfully achieve an attack goal (e.g., privilege escalation).

Second, the container images are malicious. The container images include malware that may target the host operating system or attack the container engine. This malicious program uses the sensitive system calls to successfully achieve its goals.

The related art is imperfect in finding an executable process in the container images. Consequently, there is a problem in that a scope of image analysis is narrowed.

In addition, since the related art analyzes the entire container image, overhead and cost increase. In addition, the related art for blocking and controlling system calls is not optimized for a system call filtering profile.

One of the reasons why the related art is not optimized is that, there are cases in which the system calls should be sometimes used in order to run applications in container images even though the system calls may be determined to be sensitive or vulnerable, but there is a problem in the related art that the system calls filter such sensitive but essential system calls when the system calls are blocked.

### DETAILED DESCRIPTION

### Technical Problem

The present invention is directed to providing a comprehensive method of analyzing a list of system calls used in a container based on a container image, a mechanism for optimizing the list of the system calls for the container, and a method of analyzing a container system call configuration error for providing seccomp profile generation based on the list of the system calls optimized to reconfigure a container engine.

The present invention is also directed to providing a recording medium on which a computer program for performing the method of analyzing the container system call configuration error is recorded.

The present invention is also directed to providing an apparatus for performing the method of analyzing the container system call configuration error.

### Technical Solution

One aspect of the present invention provides a method of analyzing a container system call configuration error, including: profiling a set of trusted images that are uploaded to a public or private container image repository during initialization of a system or verified by a repository owner; identifying a custom service layer and known service layers based on the trusted image when a custom image is transmitted to the system; analyzing only the custom service layer by a system call extraction engine; and generating and optimizing a profile with an essential and non-malicious system call by scanning the custom service layer to remove a malicious program or a vulnerable system call.

The method may further include performing scoring to automatically determine whether the system call is included in a white list system call list when the custom service layer includes the malicious program or vulnerability.

The performing of the scoring may include: performing an inspection from a high level system call to a low level system call in the system call list; and calculating a final score for a risk of the system call list.

The calculating of the final score for the risk of the system call list may include calculating the final score for the risk of the system call list based on an index and a penalty value of each risk level.

The method may further include providing a scoring result to a manager to approve or reject the system call.

The optimizing may include: notifying a manager of the malicious program or the vulnerability of the custom service layer when the system call with the malicious program or the vulnerability is found; and blocking deployment of the custom image.

The method may further include updating the seccomp profile to a database as an analysis result of the custom service layer.

Another aspect of the present invention provides a computer-readable storage medium on which a computer program for performing the method of analyzing a container system call configuration error is recorded.

Still another aspect of the present invention provides an apparatus for analyzing a container system call configuration error, including: an image profiler configured to profile a set of trusted images that are uploaded to a public or private container image repository during initialization of a system or verified by a repository owner; an image layer classifier configured to identify a custom service layer and known service layers based on the trusted image when a custom image is transmitted to the system; an image analyzer configured to analyze only the custom service layer by a system call extraction engine; and an optimizer configured to generate and optimize a profile with an essential and non-malicious system call by scanning the custom service layer to remove a malicious program or a vulnerable system call.

The apparatus may further include a scorer configured to perform scoring to automatically determine whether the system call is included in a white list system call list when the custom service layer includes the malicious program or vulnerability.

The scorer may include: an inspector configured to perform an inspection from a high level system call to a low level system call in the system call list; and a calculator configured to calculate a final score for a risk of the system call list.

The calculator may calculate a final score for the risk of the system call list based on an index and a penalty value of each risk level.

The scorer may further include a provider configured to provide a scoring result to a manager to approve or reject the system call.

The optimizer may include: a notifier configured to notify a manager of the malicious program or the vulnerability of the custom service layer when the system call with the malicious program or the vulnerability is found; and a blocker configured to block distribution of the custom image.

The apparatus may further include an updater configured to update the seccomp profile to a database as an analysis result of the custom service layer.

### Advantageous Effects

According to the method of analyzing a container system call configuration error, there is provided a comprehensive method of optimizing a container image scanning process to generate a system call filtering profile. By separating a custom image into two parts, it is possible to reduce an overhead of having to scan an entire image by avoiding re-analysis of known images. In addition, a scoring system may analyze a custom container image and optimize a system call filtering profile.

### DESCRIPTION OF DRAWINGS

FIG. 1 is a diagram for conceptually describing the present invention in terms of time.

FIG. 2 is a block diagram of an apparatus for analyzing a container system call configuration error according to an embodiment of the present invention.

FIG. 3 is a block diagram of an optimizer of FIG. 2.

FIG. 4 is a block diagram of a scorer of FIG. 2.

FIG. 5 is a flowchart of a method of analyzing a container system call configuration error according to an embodiment of the present invention.

FIG. 6 is a flowchart for a scoring operation of FIG. 5.

### MODES OF THE INVENTION

Embodiments of the present invention will be described in detail with reference to the accompanying drawings. These embodiments will be described in detail for those skilled in the art in order to practice the present invention. It should be appreciated that various exemplary embodiments of the present invention are different from each other, but do not have to be exclusive. For example, specific shapes, structures, and characteristics described in the present specification may be implemented in another exemplary embodiment without departing from the objective and the scope of the present invention in connection with an exemplary embodiment. In addition, it should be understood that a position or an arrangement of individual components in each disclosed exemplary embodiment may be changed without departing from the objective and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawings.

Hereinafter, exemplary embodiments of the present invention will be described in more detail with reference to the accompanying drawings.

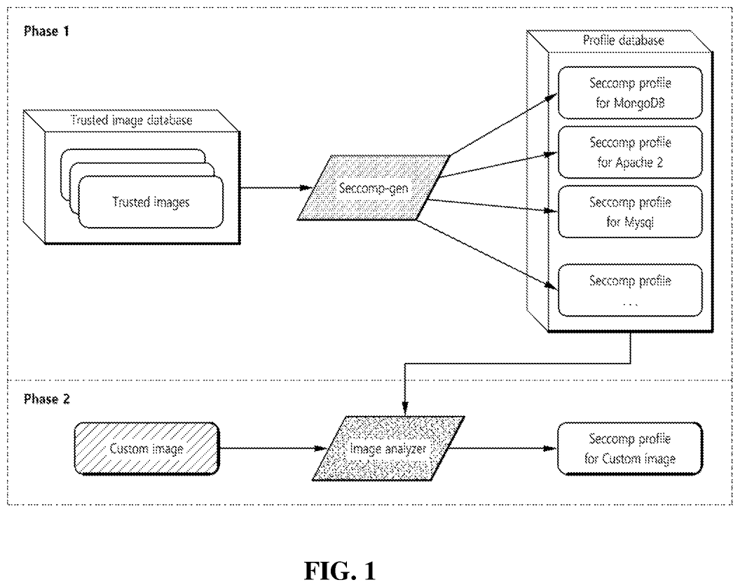

FIG. 1 is a diagram for conceptually describing the present invention in terms of time.

Referring to FIG. 1, the present invention may be divided into a trusted image seccomp profiling process (phase 1) and an optimized image analysis process (phase 2) for generating a seccomp policy.

First, phase 1 is performed during initialization of a system and performed ahead of any attacks. The main goal of this process is to profile and generate a set of trusted (official) images from verified vendors such as MongoDB and Apache.

Phase 2 is performed when one custom image is transmitted to the system for deployment. The main purpose of this process is to analyze and optimize the seccomp profile for the custom image before the image is deployed on the system.

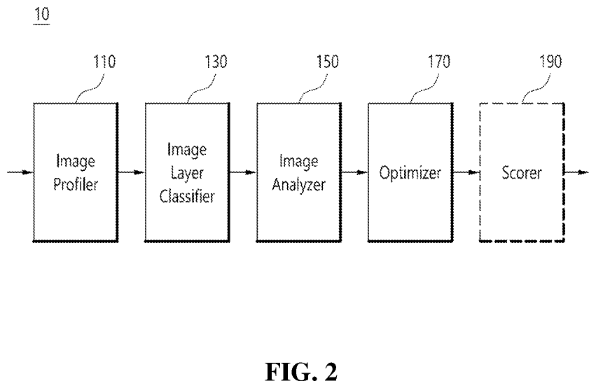

FIG. 2 is a block diagram of an apparatus for analyzing a container system call configuration error according to an embodiment of the present invention.

The apparatus 10 (hereinafter, apparatus) for analyzing a container system call configuration error according to the present invention avoids re-analysis of known images by separating a custom image into two parts, and optimizes a system call filtering profile by approving or rejecting dangerous system calls based on a scoring system.

Referring to FIG. 2, the apparatus 10 according to an embodiment of the present invention includes an image profiler 110, an image layer classifier 130, an image analyzer 150, and an optimizer 170. In another embodiment, the apparatus 10 may further include a scorer 190 and an updater (not illustrated).

The apparatus 10 may execute software (an application) for performing analysis on a container system call configuration error installed therein, and the configuration of the image profiler 110, the image layer classifier 130, the image analyzer 150, the optimizer 170, the scorer 190, and the updater (not illustrated) may be controlled by software for performing the analysis on the container system call configuration error that is executed on the apparatus 10.

The apparatus 10 may be a separate terminal or a part of a module of the terminal. In addition, the configuration of the image profiler 110, the image layer classifier 130, the image analyzer 150, the optimizer 170, the scorer 190, and the updater (not illustrated) may be formed as an integrated module or may be formed in one or more modules. However, on the other hand, each configuration may be configured as a separate module. The apparatus 10 may be movable or stationary. The apparatus 10 may be in the form of a server or an engine, and may be called by another term such as “device,” “application,” “terminal,” “user equipment (UE),” “mobile station (MS),” “wireless device,” or “handheld device.”

The apparatus 10 may execute or manufacture various types of software based on an operating system (OS), that is, a system. The OS is a system program for software to use the hardware of the apparatus, and may include both a mobile computer OS such as Android OS, iOS, Windows Mobile OS, Bada OS, Symbian OS, or Blackberry OS and a computer OS such as Windows series, Linux series, Unix series, MAC, AIX, or HP-UX.

The image profiler 110 profiles a set of trusted images during the initialization of the system.

In the present invention, a trusted image is defined as an image that is pushed (uploaded) to a public container image repository (or private repository) or verified by a repository owner.

The trusted image is usually used as a base image. In the container image, the base image becomes the first layer. The trusted images are downloaded or pulled from a trusted public repository (or private repository).

Most basic components of the container image, such as the system OS, are included in the base image (first layer) of the container image. In the present invention, there is no need to re-analyze these layers, which may greatly reduce the analysis cost and overhead.

The trusted images are analyzed only once to generate the seccomp profile. The present invention may reuse the existing seccomp generation techniques and tools to complete this task.

The seccomp of each trusted image may be stored in the seccomp profile database for later use.

When the custom image is transmitted to the system, the image layer classifier 130 identifies the custom service layer and the known service layer based on the trusted image.

In the present invention, the known service layer (generally made from the trusted image) does not need to be re-analyzed. The system first fetches the seccomp profile of the corresponding known service from the seccomp profile database by reading the metadata of the container image.

The image analyzer 150 analyzes only the custom service layer by the system call extraction engine.

In the present invention, only the custom layer is analyzed by the system call extraction engine. The system call extraction engine needs to analyze a small portion of the image of the container including the custom service. For example, the information on the custom service may be provided by a developer.

The seccomp profile obtained from the seccomp profile database and the information (e.g., JSON profile format) on the custom service are compared to determine whether an additional system call is required in the system.

The optimizer 170 optimizes to generate a profile with an essential and non-malicious system call by scanning the custom service layer removing a malicious program or a vulnerable system call.

The custom layers are scanned for malware and vulnerabilities, notifications are transmitted to a manager and images are blocked if custom service layers include malicious programs or vulnerabilities.

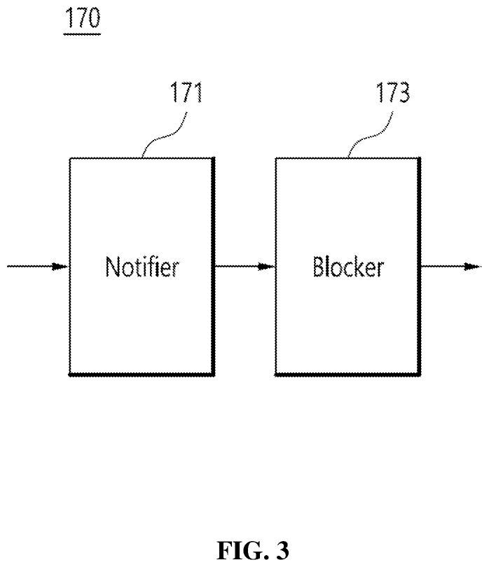

To this end, referring to FIG. 3, the optimizer 170 may further include a notifier 171 that notifies the manager of the malicious program or vulnerability of the custom service layer and a blocker 173 that blocks the deployment of the custom image.

When the custom service layer includes the malicious program or vulnerability, the scorer 190 performs scoring of automatically determining whether the system call should be included in the whitelist system call list.

That is, the dangerous system calls are summarized and known in the scorer 190. The manager may approve or reject the system call of the sensitive list based on his knowledge or the suggestion of the scorer 190.

The main purpose of the scorer 190 is to automatically determine whether the system call should be included in the whitelist system call list.

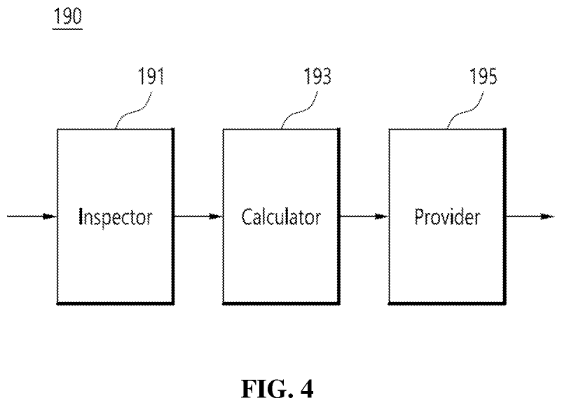

Referring to FIG. 4, the scorer 190 may include an inspector 191, a calculator 193, and a provider 195. The scorer 190 is an optional configuration of the apparatus 10, and may give useful suggestions to the manager for determining the seccomp profile.

In one embodiment, depending on the effect of the system call on the OS, it may have three levels that are high, medium, and low. When the level is the same, it means that they have the same level of risk.

The inspector 191 performs the inspection from a high level system call to a low level system call when the system call list is given after the list operation.

The calculator 193 may calculate the total score of the system call list. For example, the final score of the system call list may be calculated as in Equation 1 below.

Final score=Total score+I*M [Equation 1]

Here, I represents an index (e.g., A, B, and C) of each risk level, and M represents a penalty value. The penalty value may be set by the manager, and when M is high, it may be less likely that the dangerous system call will be added to the profile.

The updater (not illustrated) updates the seccomp profile in the database as the analysis result of the custom service layer.

Since the custom image is separated into two parts in the present invention, it is possible to reduce the overhead of scanning the entire image by avoiding the re-analysis of the known images. In addition, the scoring method may be used to help the system manager to analyze the custom container image and then optimize the system call filtering profile.

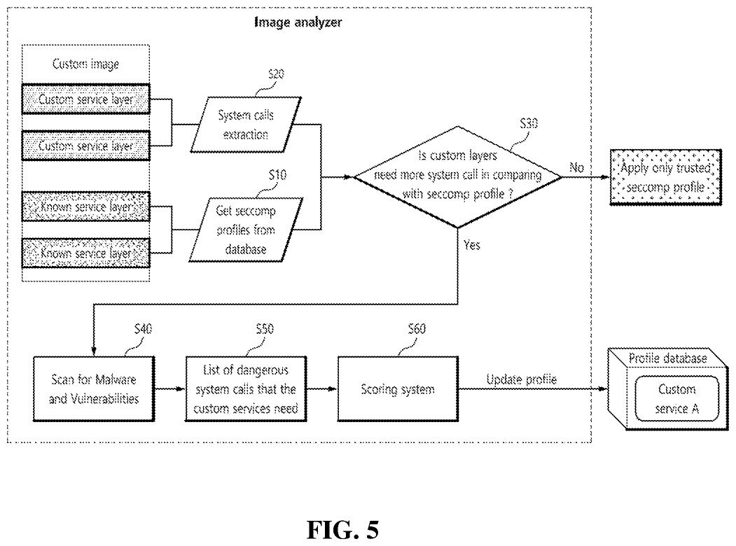

FIG. 5 is a flowchart of a method of analyzing a container system call configuration error according to an embodiment of the present invention.

The method of analyzing a container system call configuration error according to the present embodiment may be performed in substantially the same configuration as the apparatus 10 of FIG. 2. Accordingly, the same components as those of the apparatus 10 of FIG. 2 are denoted by the same reference numerals, and repeated description thereof will be omitted.

In addition, the method of analyzing a container system call configuration error according to the present embodiment may be executed by software (an application) for performing the analysis on the container system call configuration error.

The present invention avoids the re-analysis of the known images by separating the custom image into two parts, and optimizes the system call filtering profile by approving or rejecting the dangerous system calls based on the scoring system.

Referring to FIG. 5, in the method of analyzing a container system call configuration error according to the present embodiment, first, a set of trusted images, which are uploaded to a public or private container image repository during the initialization of the system or verified by the repository owner, is profiled.

In the present invention, the trusted image is defined as an image that is pushed (uploaded) to a public container image repository (or private repository) or verified by a repository owner.

The trusted image is usually used as a base image. In the container image, the base image becomes the first layer. The trusted images are downloaded or pulled from a trusted public repository (or private repository).

Most basic components of the container image, such as the system OS, are included in the base image (first layer) of the container image. In the present invention, there is no need to re-analyze these layers, which may greatly reduce the analysis cost and overhead.

The trusted images are analyzed only once to generate the seccomp profile. The present invention may reuse the existing seccomp generation techniques and tools to complete this task.

The seccomp of each trusted image may be stored in the seccomp profile database for later use.

Then, when one custom image is transmitted to the system for deployment, the seccomp profile for the custom image is analyzed and optimized before the image is deployed on the system.

For this, when the custom image is transmitted to the system, the custom service layer and the known service layers based on the trusted image are identified.

In the present invention, the known service layer (generally made from the trusted image) does not need to be re-analyzed. The system first fetches the seccomp profile of the corresponding known service from the seccomp profile database by reading the metadata of the container image (operation S10).

In the present invention, only the custom layer is analyzed by the system call extraction engine (operation S20). The system call extraction engine needs to analyze a small portion of the image of the container including the custom service. For example, the information on the custom service may be provided by a developer.

The seccomp profile obtained from the seccomp profile database and the information (e.g., JSON profile format) on the custom service are compared to determine whether an additional system call is required in the system (operation S30).

When the additional system is required, the optimizer 170 optimizes to generate the profile with the essential and non-malicious system call (operation S50) by scanning the custom service layer (operation S40) and removing the malicious program or the vulnerable system call. When the system call with the malicious program or the vulnerability is found, a manager may be notified of the malicious program or the vulnerability of the custom service layer.

In addition, when the custom service layer includes the malicious program or the vulnerability, it is possible to perform scoring to automatically determine whether the system call is included in a whitelist system call list (operation S6).

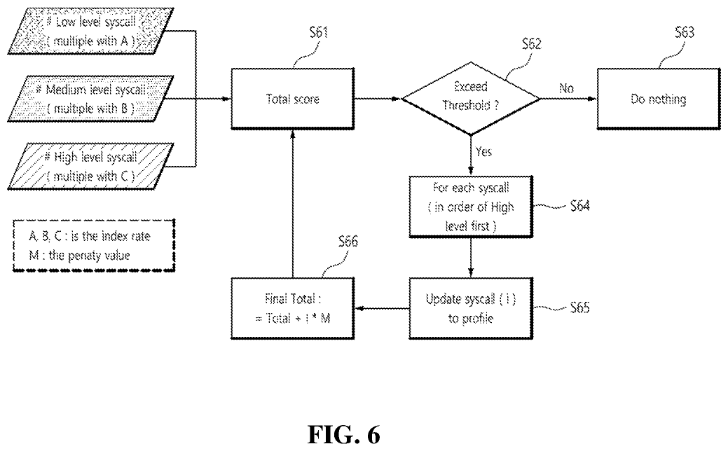

Referring to FIG. 6, in the performing of the scoring, a total score for risk may be calculated by performing an inspection of the system call list from a high level system call to a low level system call (step S61).

When the total score for the risk is lower than the preset threshold (operation S62), the process ends (operation S63). On the other hand, when the total score for the risk is higher than the preset threshold (operation S62), the profile of each system call is updated (operation S65) by performing the inspection of the system call list from the high level system to the low level system (operation S64).

In addition, the final score of the system call list is calculated (step S66). For example, the final score of the system call list may be calculated based on the index value of each risk level and penalty value.

In addition, the scoring result is provided to the manager to allow the manager to approve or reject the system call, thereby giving the manager useful suggestions to determine the seccomp profile.

As the analysis result of the custom service layer, the seccomp profile may be updated in the database.

Since the custom image is separated into two parts in the present invention, it is possible to reduce the overhead of having to scan the entire image by avoiding the re-analysis of the known images. In addition, the scoring method may use the scoring method to help the system manager to analyze the custom container image and then optimize the system call filtering profile.

Such a method of analyzing a container system call configuration error may be implemented as an application or implemented in the form of a program command that may be executed through various computer components and recorded on a computer-readable recording medium. The computer-readable recording medium may include a program command, a data file, a data structure, or the like, alone or a combination thereof.

The program instructions recorded on the computer-readable recording medium may be specially designed and constituted for the present invention or be known to those skilled in the field of computer software.

Examples of the computer-readable recording media may include a magnetic medium such as a hard disk, a floppy disk, or a magnetic tape, an optical recording medium such as a compact disk read only memory (CD-ROM) or a digital versatile disk (DVD), a magneto-optical medium such as a floptical disk, and a hardware device specially configured to store and execute program commands, such as a read only memory (ROM), a random access memory (RAM), a flash memory, or the like.

Examples of the program instructions include a high level language code capable of being executed by a computer using an interpreter, or the like, as well as a machine language code created by a compiler. The hardware device may be constituted to be operated as one or more software modules to perform processing according to the present invention, and vice versa.

Although the embodiments of the present invention have been described hereinabove, those skilled in the art will be able to understand that the present invention may be variously modified and altered without departing from the spirit and scope of the present invention disclosed in the following claims.

### INDUSTRIAL APPLICABILITY

The present invention proposes a method of optimizing a container image scanning process to generate a system call filtering profile, and therefore can be useful in a vulnerability scan application, a vulnerability list check application, etc.

### EXPLANATION OF REFERENCE NUMERALS

10: apparatus

110: image profiler

130: image layer classifier

150: image analyzer

170: optimizer

190: scorer

171: notifier

173: blocker

191: inspector

193: calculator

195: provider

1. A method of analyzing a container system call configuration error, the method comprising:
profiling a set of trusted images uploaded to a public or private container image repository during initialization of a system or verified by a repository owner;
identifying a custom service layer and known service layers based on a trusted image when a custom image is transmitted to the system;
analyzing only the custom service layer by a system call extraction engine; and
generating and optimizing a profile having an essential and non-malicious system call by scanning the custom service layer and removing a system call having a malicious program or a vulnerability.

2. The method of claim 1, further comprising: when the custom service layer includes the malicious program or the vulnerability, scoring to automatically determine whether a system call is included in a whitelist system call list.

3. The method of claim 2, wherein the scoring comprises:
inspecting a system call list from a high level system call to a low level system call; and
calculating a final score for a risk of the system call list.

4. The method of claim 3, wherein the final score for the risk of the system call list is calculated based on an index value of each risk level and penalty value.

5. The method of claim 2, further comprising providing a scoring result to a manager to approve or reject the system call.

6. The method of claim 1, wherein the optimizing the profile comprises:
notifying a manager of the malicious program or the vulnerability of the custom service layer when the system call having the malicious program or the vulnerability is found; and
blocking deployment of the custom image.

7. The method of claim 1, further comprising updating a seccomp profile to a database as an analysis result of the custom service layer.

8. A non-transitory computer-readable storage medium on which a computer program for executing the method of analyzing a container system call configuration error of claim 1 is recorded.

9. An apparatus for analyzing a container system call configuration error, the apparatus comprising:
an image profiler configured to profile a set of trusted images uploaded to a public or private container image repository during initialization of a system or verified by a repository owner;
an image layer classifier configured to identify a custom service layer and known service layers based on a trusted image when a custom image is transmitted to the system;
an image analyzer configured to analyze only the custom service layer by a system call extraction engine; and
an optimizer configured to generate and optimize a profile having an essential and non-malicious system call by scanning the custom service layer and removing a system call having a malicious program or a vulnerability.

10. The apparatus of claim 9, further comprising a scorer configured to, when the custom service layers includes the malicious program or the vulnerability, score to automatically determine whether a system call is included in a whitelist system call list.

11. The apparatus of claim 10, wherein the scorer comprises:
an inspector configured to inspect a system call list from a high level system call to a low level system call; and
a calculator configured to calculate a final score for a risk of the system call list.

12. The apparatus of claim 11, wherein the calculator calculates the final score for the risk of the system call list based on an index value of each risk level and penalty value.

13. The apparatus of claim 10, wherein the scorer comprises a provider configured to provide a scoring result to a manager to approve or reject the system call.

14. The apparatus of claim 9, wherein the optimizer comprises:
a notifier configured to notify a manager of the malicious program or the vulnerability of the custom service layer when the system call having the malicious program or the vulnerability is found; and
a blocker configured to block deployment of the custom image.

15. The apparatus of claim 9, further comprising an updater configured to update a seccomp profile to a database as an analysis result of the custom service layer.
